(19) United States
(12) Patent Application Publication
(10) Pub. No.: US 2016/0242197 A1
(43) Pub. Date: Aug. 18, 2016

(54) RESOURCE SCHEDULING METHOD AND APPARATUS AND COMMUNICATION SYSTEM

(71) Applicant: FUJITSU LIMITED, Kawasaki-shi (JP)

(72) Inventors: Weiwei WANG, Beijing (CN); Xin WANG, Beijing (CN)

(21) Appl. No.: 15/045,010

(22) Filed: Feb. 16, 2016

(30) Foreign Application Priority Data
Feb. 16, 2015 (CN) 201510083783.9

(51) Int. Cl. H04W 72/12; H04W 72/04; H04L 5/14

(52) U.S. Cl. CPC H04W 72/121; H04L 5/14; H04W 72/0473; H04W 72/0446

(57) ABSTRACT

Embodiments of the present disclosure provide a resource scheduling method and apparatus and a communication system. The method includes: a base station determines a set of user equipments to be scheduled; for a resource at a time slot, selects a pair of user equipments to be scheduled from the set of user equipments based on an objective function, the pair of user equipments including an uplink user equipment and a downlink user equipment; and allocates the resource and sets corresponding power for the pair of user equipments being scheduled. With the embodiments of the present disclosure, not only a relatively good pair of user equipments may be selected, but also fairness of uplink and downlink throughput is taken into account, thereby satisfying actual demands of a full-duplex or virtual full-duplex system.

### TECHNICAL FIELD

The present disclosure relates to the field of wireless communication technologies, and in particular to a resource scheduling method and apparatus in a full-duplex or virtual full-duplex system and a communication system.

### BACKGROUND

In a half-duplex system, the same resource can only be scheduled as being uplink or downlink. Control of uplink and downlink throughput is performed by setting different uplink and downlink time slots. In a full-duplex system, the same resource can be scheduled as being uplink and downlink at the same time, which is advantageous to increase of the system capacity. Control of uplink and downlink throughput needs also to be taken into account in a design of a scheduling algorithm, so as to satisfy demands of different uplink and downlink throughput.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

It was found by the inventors that in an existing full-duplex scheduling mechanism, selection of a pair of user equipments is mainly taken into account, and less attention is paid to fairness of the uplink and downlink throughput. However, in a practical system, uplink throughput or downlink throughput cannot be always increased while the throughput in the other direction is neglected. Hence, it is necessary to take actual demands for uplink and downlink throughput into account in resource scheduling.

Embodiments of the present disclosure provide a resource scheduling method and apparatus and a communication system. In resource scheduling in a full-duplex or virtual full-duplex system, actual demands for uplink and downlink throughput are taken into account.

According to a first aspect of the embodiments of the present disclosure, there is provided a resource scheduling apparatus, configured in a full-duplex or virtual full-duplex system, the apparatus including:

a set determining unit configured to determine a set of user equipments to be scheduled;

a user selecting unit configured to, for a resource at a time slot, select a pair of user equipments to be scheduled from the set of user equipments based on an objective function; wherein the pair of user equipments comprises an uplink user equipment and a downlink user equipment, and following parameters are taken into account in the objective function: uplink throughput and downlink throughput that can be achieved by the pair of user equipments in the resource at the time slot, and uplink throughput and downlink throughput in the coverage of a base station; and

a resource allocating unit configured to allocate the resource and set corresponding power for the pair of user equipments being scheduled.

According to a second aspect of the embodiments of the present disclosure, there is provided a resource scheduling method, applicable to a full-duplex or virtual full-duplex system, the method including:

determining, by a base station, a set of user equipments to be scheduled;

for a resource at a time slot, selecting a pair of user equipments to be scheduled from the set of user equipments based on an objective function, the pair of user equipments comprising an uplink user equipment and a downlink user equipment; and

allocating the resource and setting corresponding power for the pair of user equipments being scheduled;

wherein, following parameters are taken into account in the objective function: uplink throughput and downlink throughput that can be achieved by the pair of user equipments in the resource at the time slot, and uplink throughput and downlink throughput in the coverage of the base station.

According to a third aspect of the embodiments of the present disclosure, there is provided a communication system, performing full-duplex or virtual full-duplex communication, the communication system including:

a base station configured to determine a set of user equipments to be scheduled, for a resource at a time slot, select a pair of user equipments to be scheduled from the set of user equipments based on an objective function, and allocate the resource and set corresponding power for the pair of user equipments being scheduled;

wherein, the pair of user equipments comprises an uplink user equipment and a downlink user equipment, and following parameters are taken into account in the objective function: uplink throughput and downlink throughput that can be achieved by the pair of user equipments in the resource at the time slot, and uplink throughput and downlink throughput in the coverage of the base station.

An advantage of the embodiments of the present disclosure exists in that following parameters are taken into account in the resource scheduling: uplink throughput and downlink throughput that can be achieved by the pair of user equipments in the resource at the time slot, and uplink throughput and downlink throughput in the coverage of a base station; not only a relatively good pair of user equipments may be selected, but also fairness of uplink and downlink throughput is taken into account, thereby satisfying actual demands of a full-duplex or virtual full-duplex system.

With reference to the following description and drawings, the particular embodiments of the present disclosure are disclosed in detail, and the principles of the present disclosure and the manners of use are indicated. It should be understood that the scope of the embodiments of the present disclosure is not limited thereto. The embodiments of the present disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. It is obvious that the accompanying drawings in the following description are some embodiments of the present disclosure only, and a person of ordinary skill in the art may further obtain other drawings according to these accompanying drawings without making an inventive effort. In the drawings:

FIG. 1 is a schematic diagram of virtual full-duplex of an embodiment of the present disclosure;

FIG. 2 is a schematic diagram of full-duplex of an embodiment of the present disclosure;

FIG. 3 is a flowchart of the resource scheduling method of an embodiment of the present disclosure;

FIG. 4 is another flowchart of the resource scheduling method of the embodiment of the present disclosure;

FIG. 5 is a schematic diagram of selecting a pair of user equipments for a resource at a time slot of an embodiment of the present disclosure;

FIG. 6 is a schematic diagram of calculating an objective value for a pair of candidate user equipments of an embodiment of the present disclosure;

FIG. 7 is a schematic diagram of the resource scheduling apparatus of an embodiment of the present disclosure;

FIG. 8 is a schematic diagram of a user selecting unit of an embodiment of the present disclosure;

FIG. 9 is a schematic diagram of an objective value calculating unit of an embodiment of the present disclosure;

FIG. 10 is a schematic diagram of the communication system of an embodiment of the present disclosure; and

FIG. 11 is a schematic diagram of a structure of the base station of an embodiment of the present disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of the present disclosure, following two types of full-duplex mechanism are taken into account:

A) virtual full-duplex: within the coverage of a transmission point (this coverage may be an independent cell having cell ID, or a physical area in a cell that may be served by a serving point), a user equipment is served downlink by a transmission point, and another user equipment is served uplink by another transmission point;

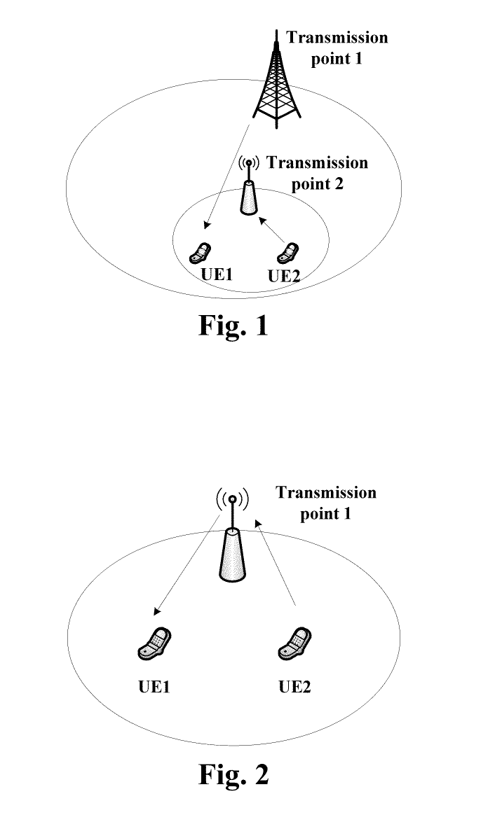

FIG. 1 is a schematic diagram of the virtual full-duplex of an embodiment of the present disclosure. As shown in FIG. 1, user equipments UE1 and UE2 are within the coverage of a transmission point 2. Within the same resource, the UE1 is served downlink by a transmission point 1 (the UE1 may be referred to as a downlink user equipment at this moment), and the UE2 is served uplink by the transmission point 2 (the UE2 may be referred to as an uplink user equipment at this moment).

B) full-duplex: a transmission point may operate in a full-duplex mode, that is, it may receive and transmit data in the same resource at the same time.

FIG. 2 is a schematic diagram of the full-duplex of an embodiment of the present disclosure. As shown on FIG. 2, the user equipments UE1 and UE2 are respectively served downlink and uplink by the transmission point 1.

In the embodiments of the present disclosure, the transmission point 2 in the virtual full-duplex mechanism should have a capability of interference cancellation, and the transmission point 1 in the full-duplex mechanism should have a capability of interference cancellation, which is advantageous to receiving an uplink signal. Such a capability of interference cancellation is modeled in the embodiments of the present disclosure.

For example, a transmission point has an inherent capability of interference cancellation, such as deleting interference of 100 dB. Or, the capability of interference cancellation of the transmission point is related to magnitude of the interference, that is, the capability is a function of the magnitude of the interference, the larger the magnitude of the interference is, the stronger the capability of interference cancellation is, and the smaller the magnitude of the interference is, the weaker the capability of interference cancellation is. The magnitude of the interference here is related to transmission power of in interference source.

The virtual full-duplex or the full-duplex is illustrated above, and the present disclosure shall be described below in detail.

### Embodiment 1

An embodiment of the present disclosure provides a resource scheduling method, applicable to a full-duplex or virtual full-duplex system.

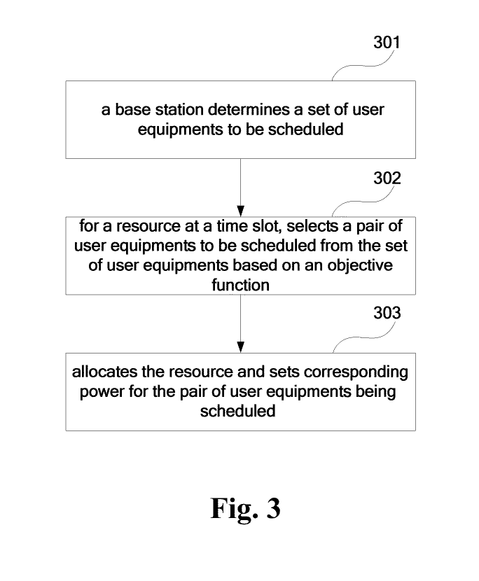

FIG. 3 is a flowchart of the resource scheduling method of the embodiment of the present disclosure. As shown in FIG. 3, the method includes:

step 301: a base station determines a set of user equipments to be scheduled;

step 302: the base station selects a pair of user equipments to be scheduled from the set of user equipments based on an objective function, for a resource at a time slot;

The pair of user equipments includes an uplink user equipment and a downlink user equipment; and following parameters are taken into account in the objective function: uplink throughput and downlink throughput that can be achieved by the pair of user equipments in the resource at the time slot, and uplink throughput and downlink throughput in the coverage of the base station;

step 303: the base station allocates the resource and sets corresponding power for the pair of user equipments being scheduled.

In this embodiment, the base station may be the transmission point 1 shown in FIGS. 1 and 2, and may also be the transmission point 2 shown in FIG. 1. For example, it may be a macro base station, may be a pico base station, and may also be a remote radio head (RRH), etc. However, the present disclosure is not limited thereto, and a particular device may be determined according to an actual scenario.

Furthermore, for the set of user equipments to be scheduled, following cases may be included: the set including all user equipments in the coverage of the base station; or the set including user equipments that is not scheduled in the allocated resource. However, the present disclosure is not limited thereto, and a particular set of user equipments may be determined according to an actual scenario.

FIG. 3 only shows a case of a resource at a certain time slot. And for multiple resources to be allocated, the base station may repeat steps 302 and 303, until all resources are allocated.

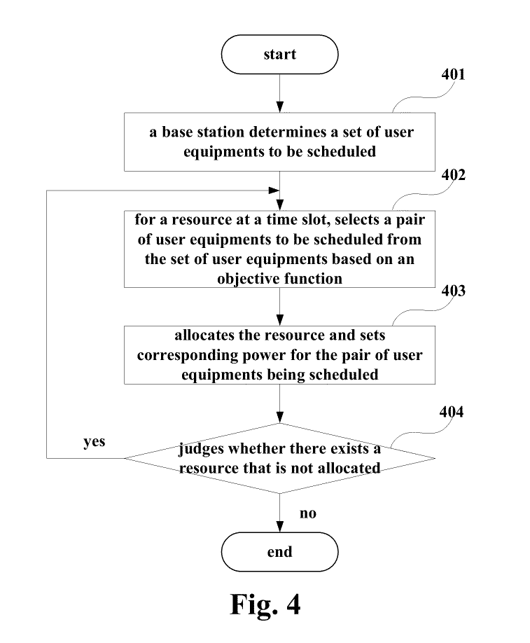

FIG. 4 is another flowchart of the resource scheduling method of the embodiment of the present disclosure. As shown in FIG. 4, the method includes:

step 401: a base station determines a set of user equipments to be scheduled;

step 402: the base station selects a pair of user equipments to be scheduled from the set of user equipments based on an objective function, for a resource at a time slot;

step 403: the base station allocates the resource and sets corresponding power for the pair of user equipments being scheduled;

step 404: the base station judges whether there exists a resource that is not allocated, executing step 402 when there exists a resource that is not allocated and continuing selecting a pair of user equipments to be scheduled and allocating resource, and terminating a process of resource allocation when there exists no resource that is not allocated.

In this embodiment, following parameters are taken into account in the objective function: uplink throughput and downlink throughput that can be achieved by the pair of user equipments in the resource at the time slot, and uplink throughput and downlink throughput in the coverage of a base station. Hence, not only a relatively good pair of user equipments may be selected, but also fairness of uplink and downlink throughput is taken into account, thereby satisfying actual demands of a full-duplex or virtual full-duplex system.

How to select a pair of user equipments (including an uplink user equipment and a downlink user equipment) for a resource at a time slot shall be described below in detail.

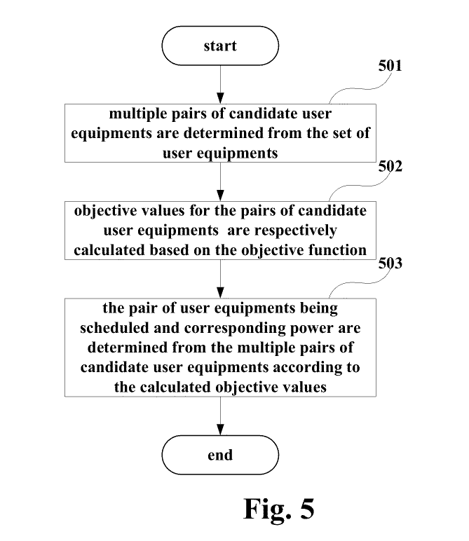

FIG. 5 is a schematic diagram of selecting a pair of user equipments for a resource at a time slot of the embodiment of the present disclosure. As shown in FIG. 5, the selection process includes:

step 501: multiple pairs of candidate user equipments are determined from the set of user equipments;

step 502: an objective value is respectively calculated for the pairs of candidate user equipments based on the objective function; and

step 503: the pair of user equipments being scheduled and corresponding power are determined from the multiple pairs of candidate user equipments according to the calculated objective values.

In an implementation, any two user equipments in the set of user equipments may be determined as a pair of candidate user equipments, so as to obtain multiple pairs of candidate user equipments. Thereafter, the objective value G(P_{DL}, P_{UL}) is calculated according to optimal uplink and downlink power settings, a finally selected pair of user equipments is a pair of user equipments making G(P_{DL}, P_{UL}) maximal at its optimal power setting.

In another implementation, a downlink (uplink) user equipment may be determined in the set of user equipments, and the downlink (uplink) user equipment and any unselected uplink (downlink) user equipment in the set of user equipments are determined as the pair of candidate user equipments, thereby obtaining the multiple pairs of candidate user equipments.

For example, a downlink user equipment (or an uplink user equipment) is selected according a rule (such as a proportional fair rule, a polling rule, and a maximum signal to interference plus noise ratio rule, etc.); and for any unselected user equipment in the set of scheduled user equipments, the objective value G(P_{DL}, P_{UL}) is calculated according to the obtained optimal uplink and downlink power settings, and finally, an uplink user equipment (or a downlink user equipment) is selected, which makes G(P_{DL}, P_{UL}) of the pair of user equipments maximal.

How to calculate the objective value for the pair of candidate user equipments shall be illustrated below.

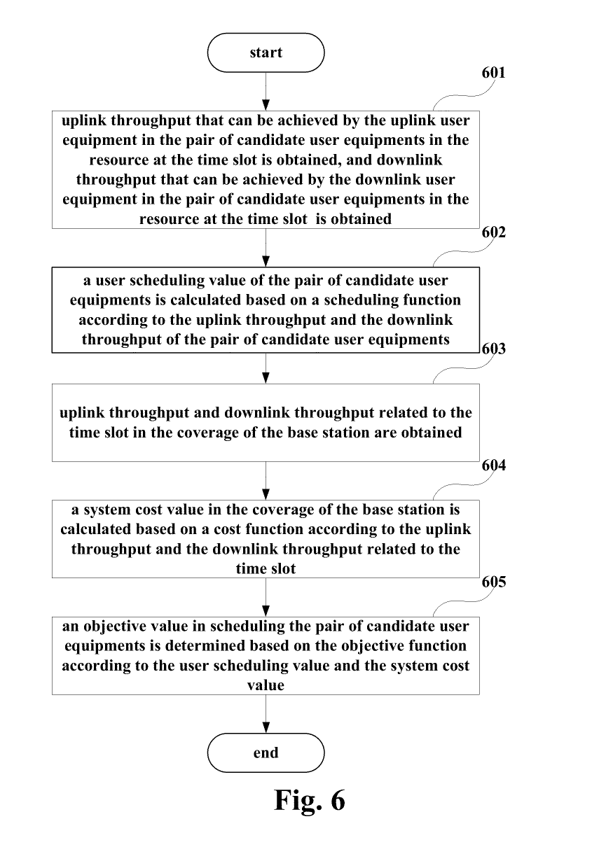

FIG. 6 is a schematic diagram of calculating the objective value for the pair of candidate user equipments of the embodiment of the present disclosure. As shown in FIG. 6, the calculation process includes:

step 601: uplink throughput that can be achieved by the uplink user equipment in the pair of candidate user equipments in the resource at the time slot is obtained, and downlink throughput that can be achieved by the downlink user equipment in the pair of candidate user equipments in the resource at the time slot is obtained;

in this embodiment, user equipment i and user equipment j are two different user equipments, Uᵢ^{DL}(t) and Uⱼ^{UL}(t) may respectively denote downlink throughput and uplink throughput that can be achieved by the downlink user equipment i and the uplink user equipment j in the resource at the time slot t;

where, Uᵢ^{DL}(t) is related to a signal to interference plus noise ratio Γ_{U}_{ᵢ}^{DL} (t) of the downlink user equipment i in the resource at the time slot t; for example, Uᵢ^{DL}(t) may be calculated according to a Shannon formula, that is, Uᵢ^{DL}(t)=BW log₂(1+Γ_{U}_{ᵢ}^{DL}(t)); where, BW denotes a bandwidth allocated to the downlink user equipment i, or, Uᵢ^{DL}(t) may also be determined by a modulation and coding scheme decided by Γ_{U}_{ᵢ}^{DL}(t);

Γ_{U}_{ᵢ}^{DL}(t) may be decided by downlink power P_{DL} and a channel Hᵢ^{DL} between the downlink user equipment i and a transmission point;

for example,

$${Γ}_{{U}_{i}}^{DL} ( t ) = \frac{{P}_{DL} {H}_{i}^{DL}}{{I}_{i}^{DL} + N} ;$$

where, Iᵢ^{DL} is interference to which the downlink user equipment i is subjected in the resource, and N is a magnitude of a noise;

furthermore, Uⱼ^{UL}(t) is related to a signal to interference plus noise ratio Γ_{U}_{ⱼ}^{UL}(t) of the uplink user equipment j in the resource at the time slot t, particular calculation being similar to the downlink calculation method;

Γ_{U}_{ⱼ}^{UL}(t) may be decided by uplink power P_{UL}, a channel Hⱼ^{UL} between the uplink user equipment j and a transmission point, and a capability if interference cancellation I_{cancel} of the transmission point;

for example,

$${Γ}_{{U}_{j}}^{UL} ( t ) = \frac{{P}_{UL} {H}_{j}^{UL}}{\frac{{I}_{j}^{UL}}{{I}_{cancel}} + N} ;$$

where, Iⱼ^{UL} is interference to which the uplink user equipment j is subjected in the resource;

it should be noted that how to calculate the uplink throughput that can be achieved by the uplink user equipment and the downlink throughput that can be achieved by the downlink user equipment is only illustrated above; however, the present disclosure is not limited thereto; for example, appropriate adjustment or variation may be performed according to the above method or formula;

step 602: a user scheduled value of the pair of candidate user equipments is calculated based on a scheduling function according to the uplink throughput and the downlink throughput of the pair of candidate user equipments;

in this embodiment, a scheduling algorithm may be used to decide the pair of user equipments that should be scheduled in each resource at the time slot t and a corresponding power setting; f(Uᵢ^{DL}(t), Uⱼ^{UL}(t)) are used to denote the scheduling function, and the scheduling function is:

in an implementation, a weighted sum of the uplink throughput and the downlink throughput that can be achieved by the pair of candidate user equipments in the resource at the time slot, that is,

f(Uᵢ^{DL}(t),Uⱼ^{UL}(t))=αUᵢ^{DL}(t)+βUⱼ^{UL}(t); where, α and β are constants;

in another implementation, taking a proportional fair rule into account, a weighted sum of the uplink throughput and the downlink throughput that can be achieved by the pair of candidate user equipments in the resource at the time slot, in a case where all user equipments are made as possible to obtain a fair scheduled opportunity, that is,

$$f ( {U}_{i}^{DL} ( t ) , {U}_{j}^{UL} ( t ) ) = \frac{α {U}_{i}^{DL} ( t )}{{T}_{i}^{DL} ( t - 1 )} + \frac{β {U}_{j}^{UL} ( t )}{{T}_{j}^{UL} ( t - 1 )} ;$$

where, Tᵢ^{DL}(t−1) and Tⱼ^{UL}(t−1) denote respectively downlink throughput and uplink throughput that are accumulated respectively by the downlink user equipment i and the uplink user equipment j at the time slot t−1, or denote downlink throughput and uplink throughput that are accumulated respectively by the downlink user equipment i and uplink user equipment j from the end of the time slot t−1 to within m time slots;

it should be noted that the scheduling function is only illustrated above; however, the present disclosure is not limited thereto, and a particular scheduling function may be determined according to an actual situation;

step 603: uplink throughput and downlink throughput related to the time slot in the coverage of the base station are obtained;

in this embodiment, C_{DL}(t−1) and C_{UL}(t−1) denote respectively the downlink throughput and uplink throughput in the coverage of the base station at the end of a time slot t−1, or denote the downlink throughput and uplink throughput in the coverage of the base station from the end of the time slot t−1 to within m time slots;

step 604: a system cost value in the coverage of the base station is calculated based on a cost function according to the uplink throughput and the downlink throughput related to the time slot;

in this embodiment, the cost function satisfies the following condition: a ratio of the uplink throughput and the downlink throughput in the coverage of the base station is in consistence with a predefined value or within a predefined interval as possible;

that is, a requirement on

$$\frac{{C}_{DL} ( t - 1 )}{{C}_{UL} ( t - 1 )}$$

may be: for example,

$$\frac{{C}_{DL} ( t - 1 )}{{C}_{UL} ( t - 1 )} = A , A$$

being a constant; or,

$$B \leq \frac{{C}_{DL} ( t - 1 )}{{C}_{UL} ( t - 1 )} \leq C ,$$

B and C being constants;

hence, a character of the cost function

$$g ( \frac{{C}_{DL} ( t - 1 )}{{C}_{UL} ( t - 1 )} )$$

may be: if

$$\frac{{C}_{DL} ( t - 1 )}{{C}_{UL} ( t - 1 )}$$

satisfies the condition,

$$g ( \frac{{C}_{DL} ( t - 1 )}{{C}_{UL} ( t - 1 )} )$$

is 0 or a relatively small positive number; otherwise,

$$g ( \frac{{C}_{DL} ( t - 1 )}{{C}_{UL} ( t - 1 )} )$$

is a relatively large positive number; and the larger the difference between

$$\frac{{C}_{DL} ( t - 1 )}{{C}_{UL} ( t - 1 )}$$

and the condition needing to be satisfied is, the larger the value of

$$g ( \frac{{C}_{DL} ( t - 1 )}{{C}_{UL} ( t - 1 )} )$$

is;

for example, if the condition is

$$\frac{{C}_{DL} ( t - 1 )}{{C}_{UL} ( t - 1 )} = A ,$$

g(x) may be defined as g(x)=ax²+bx+c, a, b, c being constants, a>0, and g(A)=0; and if the condition is

$$B \leq \frac{{C}_{DL} ( t - 1 )}{{C}_{UL} ( t - 1 )} \leq C ,$$

g(x) may be defined as g(x)=ax²+bx+c, a, b, c being constants, a>0, and g(B)=g(C)=0;

it should be noted that the cost function is only illustrated above; however, the present disclosure is not limited thereto, and a particular cost function may be determined according to an actual situation;

step 605: an objective value in scheduling the pair of candidate user equipments is determined based on the objective function according to the user scheduled value and the system cost value;

in this embodiment, for a resource at a time slot, an optimizing objection may be defined as maximizing an objective function G(P_{DL}, P_{UL}), the objective function being a function of

$$f ( {U}_{i}^{DL} ( t ) , {U}_{j}^{UL} ( t ) ) and \text{/} or g ( \frac{{C}_{DL} ( t - 1 )}{{C}_{UL} ( t - 1 )} ) ;$$

for example, the objective function may be:

$$G ( {P}_{DL} , {P}_{UL} ) = f ( {U}_{i}^{DL} ( t ) , {U}_{j}^{UL} ( t ) ) - λ g ( \frac{{C}_{DL} ( t - 1 )}{{C}_{UL} ( t - 1 )} ) ;$$

where, λ is a constant;

for any pair of candidate user equipments, such as the downlink user equipment i and the uplink user equipment j, settings of optimal downlink power and optimal uplink power making

$$G ( {P}_{DL} , {P}_{UL} ) = f ( {U}_{i}^{DL} ( t ) , {U}_{j}^{UL} ( t ) ) - λ g ( \frac{{C}_{DL} ( t - 1 )}{{C}_{UL} ( t - 1 )} )$$

maximal may be obtained; and a possible method includes: calculating derivatives of P_{DL} and P_{UL} on G(P_{DL}, P_{UL}) that is, G(P_{DL}, P_{UL}))′_{P}_{_{DL}} and G(P_{DL}, P_{UL}))′_{P}_{_{UL}}, then obtaining the settings of optimal downlink power and optimal uplink power related to the pair of user equipments according to G(P_{DL}, P_{UL}))′_{P}_{_{DL}}=0 and G(P_{DL}, P_{UL}))′_{P}_{_{UL}}=0;

it should be noted that the objective function is only illustrated above; however, the present disclosure is not limited thereto, and it may also be other objective functions, only if following parameters are taken into account: uplink throughput and downlink throughput that can be achieved by the pair of user equipments in the resource at the time slot, and uplink throughput and downlink throughput in the coverage of a base station; and a particular form of an objective function may be determined according to an actual situation.

It can be seen from above embodiment that when following parameters: uplink throughput and downlink throughput that can be achieved by the pair of user equipments in the resource at the time slot, and uplink throughput and downlink throughput in the coverage of a base station, are taken into account in the resource scheduling, not only a relatively good pair of user equipments may be selected, but also fairness of uplink and downlink throughput is taken into account, thereby satisfying actual demands of a full-duplex or virtual full-duplex system.

### Embodiment 2

An embodiment of the present disclosure provides a resource scheduling apparatus, configured in a full-duplex or virtual full-duplex system, and corresponding to the resource scheduling method of Embodiment 1, with identical contents being not going to be described any further.

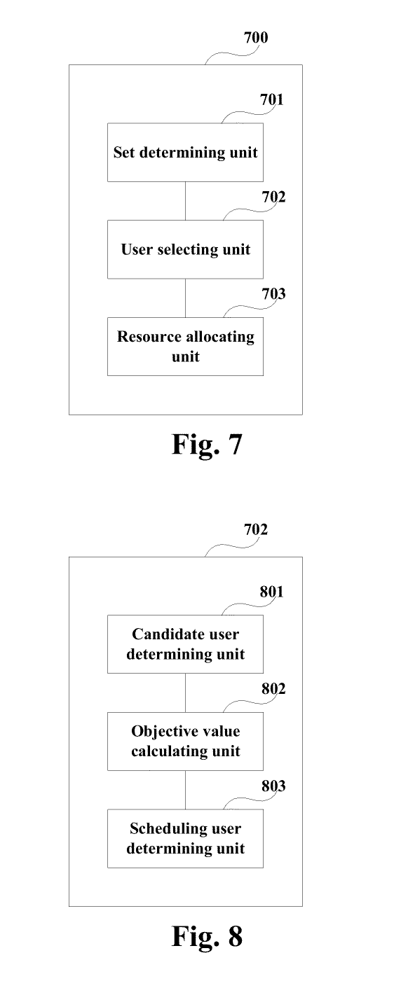

FIG. 7 is a schematic diagram of the resource scheduling apparatus of the embodiment of the present disclosure. As shown in FIG. 7, resource scheduling apparatus 700 includes:

a set determining unit 701 configured to determine a set of user equipments to be scheduled;

a user selecting unit 702 configured to, for a resource at a time slot, select a pair of user equipments to be scheduled from the set of user equipments based on an objective function; wherein the pair of user equipments comprises an uplink user equipment and a downlink user equipment, and following parameters are taken into account in the objective function: uplink throughput and downlink throughput that can be achieved by the pair of user equipments in the resource at the time slot, and uplink throughput and downlink throughput in the coverage of a base station; and

a resource allocating unit 703 configured to allocate the resource and set corresponding power for the pair of user equipments being scheduled.

FIG. 8 is a schematic diagram of the user selecting unit 702 of the embodiment of the present disclosure. As shown in FIG. 8, the user selecting unit 702 includes:

a candidate user determining unit 801 configured to determine multiple pairs of candidate user equipments from the set of user equipments;

an objective value calculating unit 802 configured to calculate objective values respectively for the pairs of candidate user equipments based on the objective function; and

a scheduling user determining unit 803 configured to determine the pair of user equipments being scheduled and corresponding power from the multiple pairs of candidate user equipments according to the calculated objective value.

The candidate user determining unit 801 may be configured to: determine any two user equipments in the set of user equipments as the pair of candidate user equipments; or

determine a downlink user equipment from the set of user equipments, and take the downlink user equipment and any unselected uplink user equipment in the set of user equipments as the pair of candidate user equipments; or determine an uplink user equipment from the set of user equipments, and take the uplink user equipment and any unselected downlink user equipment in the set of user equipments as the pair of candidate user equipment.

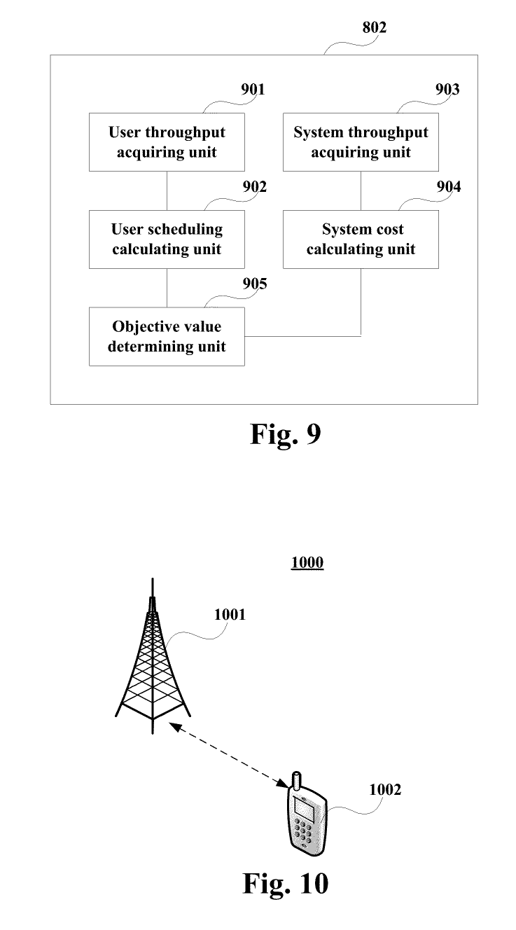

FIG. 9 is a schematic diagram of the objective value calculating unit 802 of the embodiment of the present disclosure. As shown in FIG. 9, the objective value calculating unit 802 includes:

a user throughput acquiring unit 901 configured to obtain uplink throughput that can be achieved by the uplink user equipment in the pair of candidate user equipments in the resource at the time slot and downlink throughput that can be achieved by the downlink user equipment in the pair of candidate user equipments in the resource at the time slot;

a user scheduling calculating unit 902 configured to calculate a user scheduled value of the pair of candidate user equipments based on a scheduling function according to the uplink throughput and the downlink throughput of the pair of candidate user equipments;

a system throughput acquiring unit 903 configured to obtain uplink throughput and downlink throughput related to the time slot in the coverage of the base station;

a system cost calculating unit 904 configured to calculate a system cost value in the coverage of the base station based on a cost function according to the uplink throughput and the downlink throughput related to the time slot; and

an objective value determining unit 905 configured to determine an objective value in scheduling the pair of candidate user equipments based on the objective function according to the user scheduled value and the system cost value.

In an implementation, the objective function may be:

$$G ( {P}_{DL} , {P}_{UL} ) = f ( {U}_{i}^{DL} ( t ) , {U}_{j}^{UL} ( t ) ) - λ g ( \frac{{C}_{DL} ( t - 1 )}{{C}_{UL} ( t - 1 )} ) ;$$

where, Uᵢ^{DL}(t) and Uⱼ^{UL}(t) denote respectively the downlink throughput and uplink throughput that can be achieved by the downlink user equipment i and uplink user equipment j in the resource at the time slot t; f (Uᵢ^{DL}(t), Uⱼ^{UL}(t)) denote the scheduling function; C_{DL}(t−1) and C_{UL}(t−1) denote respectively the downlink throughput and uplink throughput in the coverage of the base station at the end of a time slot t−1, or denote the downlink throughput and uplink throughput in the coverage of the base station from the end of the time slot t−1 to within m time slots;

$$g ( \frac{{C}_{DL} ( t - 1 )}{{C}_{UL} ( t - 1 )} )$$

denotes the cost function, G(P_{DL}, P_{UL}) denotes the objective function, and λ is a constant.

In an implementation, the scheduling function is: a weighted sum of the uplink throughput and the downlink throughput that can be achieved by the pair of candidate user equipments in the resource at the time slot, that is,

f(Uᵢ^{DL}(t),Uⱼ^{UL}(t))=αUᵢ^{DL}(t)+βUⱼ^{UL}(t); where α and β are constants;

or, a weighted sum of the uplink throughput and the downlink throughput that can be achieved by the pair of candidate user equipments in the resource at the time slot in a case where all user equipments are made as possible to obtain a fair scheduled opportunity, that is,

$$f ( {U}_{i}^{DL} ( t ) , {U}_{j}^{UL} ( t ) ) = \frac{α {U}_{i}^{DL} ( t )}{{T}_{i}^{DL} ( t - 1 )} + \frac{β {U}_{j}^{UL} ( t )}{{T}_{j}^{UL} ( t - 1 )} ;$$

where, Tᵢ^{DL}(t−1) and Tⱼ^{UL}(t−1) denote respectively downlink throughput and uplink throughput that are accumulated respectively by the downlink user equipment i and uplink user equipment j at the time slot t−1, or denote downlink throughput and uplink throughput that are accumulated respectively by the downlink user equipment i and uplink user equipment j from the end of the time slot t−1 to within m time slots.

In an implementation, Uᵢ^{DL}(t) is related to a signal to interference plus noise ratio Γ_{U}_{ᵢ}^{DL}(t) of the downlink user equipment i in the resource at the time slot t, and Γ_{U}_{ᵢ}^{DL}(t) is decided by downlink power P_{DL} and a channel Hᵢ^{DL} between the downlink user equipment i and a service transmission point;

and Uⱼ^{UL}(t) is related to a signal to interference plus noise ratio Γ_{U}_{ⱼ}^{UL}(t) of the uplink user equipment j in the resource at the time slot t, Γ_{U}_{ⱼ}^{UL}(t) is decided by uplink power P_{UL}, a channel Hⱼ^{UL} between the uplink user equipment j and a service transmission point, and a capability of interference cancellation I_{cancel} of the service transmission point.

In an implementation,

$${Γ}_{{U}_{i}}^{DL} ( t ) = \frac{{P}_{DL} {H}_{i}^{DL}}{{I}_{i}^{DL} + N} , and {Γ}_{{U}_{j}}^{UL} ( t ) = \frac{{P}_{UL} {H}_{j}^{UL}}{\frac{{I}_{j}^{UL}}{{I}_{cancel}} + N} ;$$

where, Iᵢ^{DL} is interference to which the downlink user equipment i is subjected in the resource, Iⱼ^{UL} is interference to which the uplink user equipment j is subjected in the resource, and N is a magnitude of a noise.

In an implementation, a ratio of the uplink throughput and the downlink throughput in the coverage of the base station is in consistence with a predefined value or within a predefined interval as possible;

and in a case where

$$\frac{{C}_{DL} ( t - 1 )}{{C}_{UL} ( t - 1 )}$$

is in consistence with the predefined value or in the predefined interval, a value of

$$g ( \frac{{C}_{DL} ( t - 1 )}{{C}_{UL} ( t - 1 )} )$$

is 0 or a positive number, and the larger the difference between

$$\frac{{C}_{DL} ( t - 1 )}{{C}_{UL} ( t - 1 )}$$

and the predefined value or the predefined
interval is, the larger the value of

$$g ( \frac{{C}_{DL} ( t - 1 )}{{C}_{UL} ( t - 1 )} )$$

is.

In an implementation,

g(x)=ax²+bx+c,a,b,c being constants, a>0, and

g(A)=0 or g(B)=g(C)=0;

where, A is the predefined value, or [B,C] is the predefined interval.

It can be seen from above embodiment that when following parameters: uplink throughput and downlink throughput that can be achieved by the pair of user equipments in the resource at the time slot, and uplink throughput and downlink throughput in the coverage of a base station, are taken into account in the resource scheduling, not only a relatively good pair of user equipments may be selected, but also fairness of uplink and downlink throughput is taken into account, thereby satisfying actual demands of a full-duplex or virtual full-duplex system.

### Embodiment 3

An embodiment of the present disclosure provides a communication system, with contents identical those in embodiments 1 and 2 being not going to be described any further. FIG. 10 is a schematic diagram of the communication system of the embodiment of the present disclosure. As shown in FIG. 10, the communication system 1000 includes: a base station 1001 and user equipment 1002;

The base station 1001 is configured to determine a set of user equipments to be scheduled; for a resource at a time slot, select a pair of user equipments to be scheduled from the set of user equipments based on an objective function; and allocate and set corresponding power the resource for the pair of user equipments being scheduled;

the pair of user equipments includes an uplink user equipment and a downlink user equipment, and following parameters are taken into account in the objective function: uplink throughput and downlink throughput that can be achieved by the pair of user equipments in the resource at the time slot, and uplink throughput and downlink throughput in the coverage of the base station.

The embodiment of the present disclosure further provides a base station, configured with the resource scheduling apparatus 700 described above.

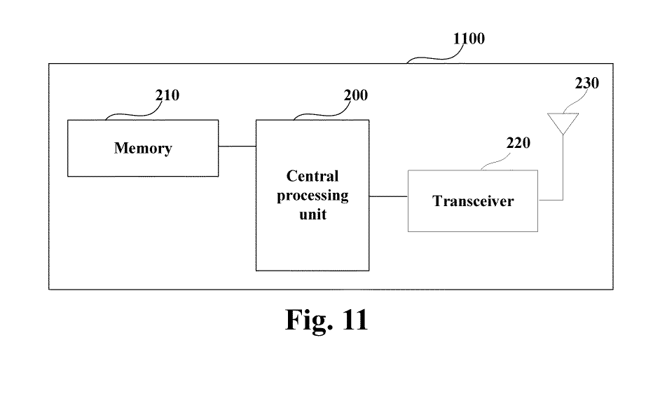

FIG. 11 is a schematic diagram of a structure of the base station of the embodiment of the present disclosure. As shown in FIG. 11, the base station 1100 may include a central processing unit (CPU) 200 and a memory 210, the memory 210 being coupled to the central processing unit 200; for example, the memory 210 may store various data, and may further store programs for information processing, and execute the programs under control of the central processing unit 200.

The base station 1100 may be configured to carry out the resource scheduling method described in Embodiment 1. The central processing unit 200 may be configured to execute functions of the resource scheduling apparatus 700, that is, the central processing unit 200 may be configured to perform the following control: determining a set of user equipments to be scheduled; for a resource at a time slot, selecting a pair of user equipments to be scheduled from the set of user equipments based on an objective function, the pair of user equipments including an uplink user equipment and a downlink user equipment; and allocating the resource and setting corresponding power for the pair of user equipments being scheduled.

Furthermore, as shown in FIG. 11, the base station 1100 may include a transceiver 220, and an antenna 230, etc.; wherein, functions of these components are similar to those in the relevant art, and shall not be described herein any further. It should be noted that the base station 1100 does not necessarily include all the parts shown in FIG. 11; and furthermore, the base station 1100 may include other components not shown in FIG. 11, and the relevant art may be referred to.

An embodiment of the present disclosure further provides a computer-readable program, wherein when the program is executed in a base station, the program enables the computer to carry out the resource scheduling method as described in Embodiment 1 in the base station.

An embodiment of the present disclosure further provides a storage medium in which a computer-readable program is stored, wherein the computer-readable program enables the computer to carry out the resource scheduling method as described in Embodiment 1 in a base station.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principles of the present disclosure, and such variants and modifications fall within the scope of the present disclosure.

For the implementation of the present disclosure containing the above embodiments, following supplements are further disclosed.

Supplement 1. A resource scheduling apparatus, configured in a full-duplex or virtual full-duplex system, the apparatus including:

a set determining unit configured to determine a set of user equipments to be scheduled;

a user selecting unit configured to, for a resource at a time slot, select a pair of user equipments to be scheduled from the set of user equipments based on an objective function; wherein the pair of user equipment includes an uplink user equipment and a downlink user equipment, and following parameters are taken into account in the objective function: uplink throughput and downlink throughput that can be achieved by the pair of user equipments in the resource at the time slot, and uplink throughput and downlink throughput in the coverage of a base station; and

a resource allocating unit configured to allocate the resource and set corresponding power for the pair of user equipments being scheduled.

Supplement 2. The apparatus according to supplement 1, wherein the user selecting unit includes:

a candidate user determining unit configured to determine multiple pairs of candidate user equipments from the set of user equipments;

an objective value calculating unit configured to calculate objective values respectively for the pairs of candidate user equipments based on the objective function; and

a scheduling user determining unit configured to determine the pair of user equipments being scheduled and the corresponding power from the multiple pairs of candidate user equipments according to the calculated objective values.

Supplement 3. The apparatus according to supplement 2, wherein the candidate user determining unit is configured to:

determine any two user equipments in the set of user equipments as the pair of candidate user equipments; or

determine a downlink user equipment from the set of user equipments, and take the downlink user equipment and any unselected uplink user equipment in the set of user equipments as the pair of candidate user equipments; or determine an uplink user equipment from the set of user equipments, and take the uplink user equipment and any unselected downlink user equipment in the set of user equipments as the pair of candidate user equipments.

Supplement 4. The apparatus according to supplement 2, wherein the objective value calculating unit includes:

a user throughput acquiring unit configured to obtain uplink throughput that can be achieved by the uplink user equipment in the pair of candidate user equipments in the resource at the time slot and downlink throughput that can be achieved by the downlink user equipment in the pair of candidate user equipments in the resource at the time slot;

a user scheduling calculating unit configured to calculate a user scheduled value of the pair of candidate user equipments based on a scheduling function according to the uplink throughput and the downlink throughput of the pair of candidate user equipments;

a system throughput acquiring unit configured to obtain uplink throughput and downlink throughput related to the time slot in the coverage of the base station;

a system cost calculating unit configured to calculate a system cost value in the coverage of the base station based on a cost function according to the uplink throughput and the downlink throughput related to the time slot; and

an objective value determining unit configured to determine an objective value in scheduling the pair of candidate user equipments based on the objective function according to the user scheduled value and the system cost value.

Supplement 5. The apparatus according to supplement 4, wherein the objective function is:

$$G ( {P}_{DL} , {P}_{UL} ) = f ( {U}_{i}^{DL} ( t ) , {U}_{j}^{UL} ( t ) ) - λ g ( \frac{{C}_{DL} ( t - 1 )}{{C}_{UL} ( t - 1 )} ) ;$$

where, Uᵢ^{DL}(t) and Iⱼ^{UL}(t) denote respectively the downlink throughput and uplink throughput that can be achieved by the downlink user equipment i and uplink user equipment j in the resource at the time slot t; f(Uᵢ^{DL}(t), Uⱼ^{UL}(t)) denote the scheduling function; C_{DL}(t−1) and C_{UL}(t−1) denote respectively the downlink throughput and uplink throughput in the coverage of the base station at the end of a time slot t−1, or denote the downlink throughput and uplink throughput in the coverage of the base station from the end of the time slot t−1 to within m time slots;

$$g ( \frac{{C}_{DL} ( t - 1 )}{{C}_{UL} ( t - 1 )} )$$

denotes the cost function, G(P_{DL}, P_{UL}) denotes the objective function, and λ is a constant.

Supplement 6. The apparatus according to supplement 5, wherein the scheduling function is:

a weighted sum of the uplink throughput and the downlink throughput that can be achieved by the pair of candidate user equipments in the resource at the time slot, that is,

f(Uᵢ^{DL}(t),Uⱼ^{UL}(t))=αUᵢ^{DL}(t)+βUⱼ^{UL}(t); where, α and β are constants;

or,

a weighted sum of the uplink throughput and the downlink throughput that can be achieved by the pair of candidate user equipments in the resource at the time slot in a case where all user equipments are made as possible to obtain a fair scheduled opportunity, that is,

$$f ( {U}_{i}^{DL} ( t ) , {U}_{j}^{UL} ( t ) ) = \frac{α {U}_{i}^{DL} ( t )}{{T}_{i}^{DL} ( t - 1 )} + \frac{β {U}_{j}^{UL} ( t )}{{T}_{j}^{UL} ( t - 1 )} ;$$

where, Tᵢ^{DL}(t−1) and Tⱼ^{UL}(t−1) denote respectively downlink throughput and uplink throughput that are accumulated respectively by the downlink user equipment i and uplink user equipment j at the time slot t−1, or denote downlink throughput and uplink throughput that are accumulated respectively by the downlink user equipment i and uplink user equipment j from the end of the time slot t−1 to within m time slots.

Supplement 7. The apparatus according to supplement 5, wherein,

Uᵢ^{DL}(t) is related to a signal to interference plus noise ratio Γ_{U}_{ᵢ}^{DL}(t) of the downlink user equipment i in the resource at the time slot t, and Γ_{U}_{ᵢ}^{DL}(t) is decided by downlink power P_{DL} and a channel Hᵢ^{DL} between the downlink user equipment i and a service transmission point;

and Uⱼ^{UL}(t) is related to a signal to interference plus noise ratio Γ_{U}_{ⱼ}^{UL}(t) of the uplink user equipment j in the resource at the time slot t, Γ_{U}_{ⱼ}^{UL}(t) is decided by uplink power P_{UL}, a channel Hⱼ^{UL} between the uplink user equipment j and a service transmission point, and a capability of interference cancellation I_{cancel} of the service transmission point.

Supplement 8. The apparatus according to supplement 7, wherein,

$${Γ}_{{U}_{i}}^{DL} ( t ) = \frac{{P}_{DL} {H}_{i}^{DL}}{{I}_{i}^{DL} + N} , \\ and {Γ}_{{U}_{j}}^{UL} ( t ) = \frac{{P}_{UL} {H}_{j}^{UL}}{\frac{{I}_{j}^{UL}}{{I}_{cancel}} + N} ;$$

where, Iᵢ^{DL} is interference to which the downlink user equipment i is subjected in the resource, Iⱼ^{UL} is interference to which the uplink user equipment j is subjected in the resource, and N is a magnitude of a noise.

Supplement 9. The apparatus according to supplement 5, wherein a ratio of the uplink throughput and the downlink throughput in the coverage of the base station is in consistence with a predefined value or within a predefined interval as possible;

and in a case where

$$\frac{{C}_{DL} ( t - 1 )}{{C}_{UL} ( t - 1 )}$$

is in consistence with the predefined value or in the predefined interval, a value of

$$g ( \frac{{C}_{DL} ( t - 1 )}{{C}_{UL} ( t - 1 )} )$$

is 0 or a positive number, and the larger the difference between

$$\frac{{C}_{DL} ( t - 1 )}{{C}_{UL} ( t - 1 )}$$

and the predefined value or the predefined interval is, the larger the value of

$$g ( \frac{{C}_{DL} ( t - 1 )}{{C}_{UL} ( t - 1 )} )$$

is.

Supplement 10. The apparatus according to supplement 9, wherein,

g(x)=ax²+bx+c,a,b,c being constants, a>0, and

g(A)=0 or g(B)=g(C)=0;

where, A is the predefined value, or [B,C] is the predefined interval.

Supplement 11. A resource scheduling method, applicable to a full-duplex or virtual full-duplex system, the method including:

determining, by a base station, a set of user equipments to be scheduled;

for same resource at a time slot, selecting a pair of user equipments to be scheduled from the set of user equipments based on an objective function, the pair of user equipments including an uplink user equipment and a downlink user equipment; and

allocating the resource and setting corresponding power for the pair of user equipments being scheduled;

wherein, following parameters are taken into account in the objective function: uplink throughput and downlink throughput that can be achieved by the pair of user equipments in the resource at the time slot, and uplink throughput and downlink throughput in the coverage of the base station.

Supplement 12. The method according to supplement 11, wherein the selecting a pair of user equipments to be scheduled from the set of user equipments based on an objective function includes:

determining multiple pairs of candidate user equipments from the set of user equipments;

calculating objective values respectively for the pairs of candidate user equipments based on the objective function; and

determining the pair of user equipments being scheduled and corresponding power from the multiple pairs of candidate user equipments according to the calculated objective value.

Supplement 13. The method according to supplement 12, wherein the determining multiple pairs of candidate user equipments from the set of user equipments includes:

determining any two user equipments in the set of user equipments as the pair of candidate user equipments; or

determining a downlink user equipment from the set of user equipments, and take the downlink user equipment and any unselected uplink user equipment in the set of user equipments as the pair of candidate user equipments; or determine an uplink user equipment from the set of user equipments, and take the uplink user equipment and any unselected downlink user equipment in the set of user equipments as the pair of candidate user equipments.

Supplement 14. The method according to supplement 12, wherein the calculating objective values respectively for the pairs of candidate user equipments based on the objective function includes:

obtaining uplink throughput that can be achieved by the uplink user equipment in the pair of candidate user equipments in the resource at the time slot and downlink throughput that can be achieved by the downlink user equipment in the pair of candidate user equipments in the resource at the time slot;

calculating a user scheduled value of the pair of candidate user equipments based on a scheduling function according to the uplink throughput and the downlink throughput of the pair of candidate user equipments;

obtaining uplink throughput and downlink throughput related to the time slot in the coverage of the base station;

calculating a system cost value in the coverage of the base station based on a cost function according to the uplink throughput and the downlink throughput related to the time slot; and

determining an objective value in scheduling the pair of candidate user equipments based on the objective function according to the user scheduled value and the system cost value.

Supplement 15. The method according to supplement 14, wherein the objective function is:

$$G ( {P}_{DL} , {P}_{UL} ) = f ( {U}_{i}^{DL} ( t ) , {U}_{j}^{UL} ( t ) ) - λ g ( \frac{{C}_{DL} ( t - 1 )}{{C}_{UL} ( t - 1 )} ) ;$$

where, Uᵢ^{DL}(t) and Uⱼ^{UL}(t) denote respectively the downlink throughput and uplink throughput that can be achieved by the downlink user equipment i and uplink user equipment j in the resource at the time slot t; f(Uᵢ^{DL}(t), Uⱼ^{UL}(t)) denote the scheduling function; C_{DL}(t−1) and C_{UL}(t−1) denote respectively the downlink throughput and uplink throughput in the coverage of the base station at the end of a time slot t−1, or denote the downlink throughput and uplink throughput in the coverage of the base station from the end of the time slot t−1 to within m time slots;

$$g ( \frac{{C}_{DL} ( t - 1 )}{{C}_{UL} ( t - 1 )} )$$

denotes the cost function, G(P_{DL}, P_{UL}) denotes the objective function, and λ is a constant.

Supplement 16. The method according to supplement 15, wherein the scheduling function is:

a weighted sum of the uplink throughput and the downlink throughput that can be achieved by the pair of candidate user equipments in the resource at the time slot, that is,

f(Uᵢ^{DL}(t),Uⱼ^{UL}(t))=αUᵢ^{DL}(t)+βUⱼ^{UL}(t); where, α and β are constants;

or,

a weighted sum of the uplink throughput and the downlink throughput that can be achieved by the pair of candidate user equipments in the resource at the time slot in a case where all user equipments are made as possible to obtain a fair scheduled opportunity, that is,

$$f ( {U}_{i}^{DL} ( t ) , {U}_{j}^{UL} ( t ) ) = \frac{α {U}_{i}^{DL} ( t )}{{T}_{i}^{DL} ( t - 1 )} + \frac{β {U}_{j}^{UL} ( t )}{{T}_{j}^{UL} ( t - 1 )} ;$$

where, Tᵢ^{DL}(t−1) and Tⱼ^{UL}(t−1) denote respectively downlink throughput and uplink throughput that are accumulated respectively by the downlink user equipment i and uplink user equipment j at the time slot t−1, or denote downlink throughput and uplink throughput that are accumulated respectively by the downlink user equipment i and uplink user equipment j from the end of the time slot t−1 to within m time slots.

Supplement 17. The method according to supplement 15, wherein,

Uᵢ^{DL}(t) is related to a signal to interference plus noise ratio Γ_{U}_{ᵢ}^{DL}(t) of the downlink user equipment i in the resource at the time slot t, and Γ_{U}_{ᵢ}^{DL}(t) is decided by downlink power P_{DL} and a channel Hᵢ^{DL} between the downlink user equipment i and a service transmission point;

and Uⱼ^{UL}(t) is related to a signal to interference plus noise ratio Γ_{U}_{ⱼ}^{UL}(t) of the uplink user equipment j in the resource at the time slot t, Γ_{U}_{ⱼ}^{UL}(t) is decided by uplink power P_{UL}, a channel Hⱼ^{DL} between the uplink user equipment j and a service transmission point, and a capability of interference cancellation I_{cancel} of the service transmission point.

Supplement 18. The method according to supplement 17, wherein,

$${Γ}_{{U}_{i}}^{DL} ( t ) = \frac{{P}_{DL} {H}_{i}^{DL}}{{I}_{i}^{DL} + N} , \\ and$$

$${Γ}_{{U}_{j}}^{UL} ( t ) = \frac{{P}_{UL} {H}_{j}^{UL}}{\frac{{I}_{j}^{UL}}{{I}_{cancel}} + N} ;$$

where, Iᵢ^{DL} is interference to which the downlink user equipment i is subjected in the resource, Iⱼ^{UL} is interference to which the uplink user equipment j is subjected in the resource, and N is a magnitude of a noise.

Supplement 19. The method according to supplement 15, wherein a ratio of the uplink throughput and the downlink throughput in the coverage of the base station is in consistence with a predefined value or within a predefined interval as possible;

and in a case where

$$\frac{{C}_{DL} ( t - 1 )}{{C}_{UL} ( t - 1 )}$$

is in consistence with the predefined value or in the predefined interval, a value of

$$g ( \frac{{C}_{DL} ( t - 1 )}{{C}_{UL} ( t - 1 )} )$$

is 0 or a positive number, and the larger the difference between

$$\frac{{C}_{DL} ( t - 1 )}{{C}_{UL} ( t - 1 )}$$

and the predefined value or the predefined interval is, the larger the value of

$$g ( \frac{{C}_{DL} ( t - 1 )}{{C}_{UL} ( t - 1 )} )$$

is.

Supplement 20. A communication system, performing full-duplex or virtual full-duplex communication, the communication system including:

a base station configured to determine a set of user equipments to be scheduled; for a resource at a time slot, select a pair of user equipments to be scheduled from the set of user equipments based on an objective function; and allocate the resource and set corresponding power for the pair of user equipments being scheduling;
wherein, the pair of user equipments includes an uplink user equipment and a downlink user equipment, and following parameters are taken into account in the objective function: uplink throughput and downlink throughput that can be achieved by the pair of user equipments in the resource at the time slot, and uplink throughput and downlink throughput in the coverage of the base station.

1. A resource scheduling apparatus, configured in a full-duplex or virtual full-duplex system, the apparatus comprising:
a set determining unit configured to determine a set of user equipments to be scheduled;
a user selecting unit configured to, for a resource at a time slot, select a pair of user equipments to be scheduled from the set of user equipments based on an objective function; wherein the pair of user equipments comprises an uplink user equipment and a downlink user equipment, and following parameters are taken into account in the objective function: uplink throughput and downlink throughput that can be achieved by the pair of user equipments in the resource at the time slot, and uplink throughput and downlink throughput in the coverage of a base station; and
a resource allocating unit configured to allocate the resource and set corresponding power for the pair of user equipments being scheduled.

2. The apparatus according to claim 1, wherein the user selecting unit comprises:
a candidate user determining unit configured to determine multiple pairs of candidate user equipments from the set of user equipments;
an objective value calculating unit configured to calculate objective values respectively for the pairs of candidate user equipments based on the objective function; and
a scheduling user determining unit configured to determine the pair of user equipments being scheduled and the corresponding power from the multiple pairs of candidate user equipments according to the calculated objective values.

3. The apparatus according to claim 2, wherein the candidate user determining unit is configured to:
determine any two user equipments in the set of user equipments as the pair of candidate user equipments; or
determine a downlink user equipment from the set of user equipments, and take the downlink user equipment and any unselected uplink user equipment in the set of user equipments as the pair of candidate user equipments; or determine an uplink user equipment from the set of user equipments, and take the uplink user equipment and any unselected downlink user equipment in the set of user equipments as the pair of candidate user equipments.

4. The apparatus according to claim 2, wherein the objective value calculating unit comprises:
a user throughput acquiring unit configured to obtain uplink throughput that can be achieved by the uplink user equipment in the pair of candidate user equipments in the resource at the time slot and downlink throughput that can be achieved by the downlink user equipment in the pair of candidate user equipments in the resource at the time slot;
a user scheduling calculating unit configured to calculate a user scheduled value of the pair of candidate user equipments based on a scheduling function according to the uplink throughput and the downlink throughput of the pair of candidate user equipments;
a system throughput acquiring unit configured to obtain uplink throughput and downlink throughput related to the time slot in the coverage of the base station;
a system cost calculating unit configured to calculate a system cost value in the coverage of the base station based on a cost function according to the uplink throughput and the downlink throughput related to the time slot; and
an objective value determining unit configured to determine an objective value in scheduling the pair of candidate user equipments based on the objective function according to the user scheduled value and the system cost value.

5. The apparatus according to claim 4, wherein the objective function is:
$$G ( {P}_{DL} , {P}_{UL} ) = f ( {U}_{i}^{DL} ( t ) , {U}_{j}^{UL} ( t ) ) - λ g ( \frac{{C}_{DL} ( t - 1 )}{{C}_{UL} ( t - 1 )} ) ;$$
where, Uᵢ^{DL}(t) and Uⱼ^{UL}(t) denote respectively the downlink throughput and uplink throughput that can be achieved by the downlink user equipment i and uplink user equipment j in the resource at the time slot t; f(Uᵢ^{UL}, Uⱼ^{UL}(t)) denote the scheduling function; C_{DL}(t−1) and C_{UL}(t−1) denote respectively the downlink throughput and uplink throughput in the coverage of the base station at the end of the time slot t−1, or denote the downlink throughput and uplink throughput in the coverage of the base station from the end of the time slot t−1 to within m time slots;
$$g ( \frac{{C}_{DL} ( t - 1 )}{{C}_{UL} ( t - 1 )} )$$
denotes the cost function, G(P_{DL}, P_{UL}) denotes the objective function, and λ is a constant.

6. The apparatus according to claim 5, wherein the scheduling function is:
a weighted sum of the uplink throughput and the downlink throughput that can be achieved by the pair of candidate user equipments in the resource at the time slot, that is,
f(Uᵢ^{DL}(t),Uⱼ^{UL}(t))=αUᵢ^{DL}(t)+βUⱼ^{UL}(t); where, α and β are constants;
or,
a weighted sum of the uplink throughput and the downlink throughput that can be achieved by the pair of candidate user equipments in the resource at the time slot in a case where all user equipments are made as possible to obtain a fair scheduled opportunity, that is,
$$f ( {U}_{i}^{DL} ( t ) , {U}_{j}^{UL} ( t ) ) = \frac{α {U}_{i}^{DL} ( t )}{{T}_{i}^{DL} ( t - 1 )} + \frac{β {U}_{j}^{UL} ( t )}{{T}_{j}^{UL} ( t - 1 )} ;$$
where, Tᵢ^{DL}(t−1) and Tⱼ^{UL}(t−1) denote respectively a downlink throughput and an uplink throughput that are accumulated respectively by the downlink user equipment i and uplink user equipment j at the time slot t−1, or denote a downlink throughput and an uplink throughput that are accumulated respectively by the downlink user equipment i and uplink user equipment j from the end of the time slot t−1 to within m time slots.

7. The apparatus according to claim 5, wherein,
Uᵢ^{DL}(t) is related to a signal to interference plus noise ratio Γ_{U}_{ᵢ}^{DL}(t) of the downlink user equipment i in the resource at the time slot t, and Γ_{U}_{ᵢ}^{DL}(t) is decided by downlink power P_{DL} and a channel Hᵢ^{DL} between the downlink user equipment i and a service transmission point;
and Uⱼ^{UL}(t) is related to a signal to interference plus noise ratio Γ_{U}_{ⱼ}^{UL}(t) of the uplink user equipment j in the resource at the time slot t, Γ_{U}_{ⱼ}^{UL}(t) is decided by uplink power P_{UL}, a channel Hⱼ^{UL} between the uplink user equipment j and a service transmission point, and a capability of interference cancellation I_{cancel} of the service transmission point.

8. The apparatus according to claim 5, wherein,
in a case where
$$\frac{{C}_{DL} ( t - 1 )}{{C}_{UL} ( t - 1 )}$$
is in consistence with a predefined value or in a predefined interval, a value of
$$g ( \frac{{C}_{DL} ( t - 1 )}{{C}_{UL} ( t - 1 )} )$$
is 0 or a positive number, and the larger the difference between
$$\frac{{C}_{DL} ( t - 1 )}{{C}_{UL} ( t - 1 )}$$
and the predefined value or the predefined interval is, the larger the value of
$$g ( \frac{{C}_{DL} ( t - 1 )}{{C}_{UL} ( t - 1 )} )$$
is.

9. A resource scheduling method, applicable to a full-duplex or virtual full-duplex system, the method comprising:
determining, by a base station, a set of user equipments to be scheduled;
for a resource at a time slot, selecting a pair of user equipments to be scheduled from the set of user equipments based on an objective function, the pair of user equipments comprising an uplink user equipment and a downlink user equipment; and
allocating the resource and setting corresponding power for the pair of user equipments being scheduled;
wherein, following parameters are taken into account in the objective function: uplink throughput and downlink throughput that can be achieved by the pair of user equipments in the resource at the time slot, and uplink throughput and downlink throughput in the coverage of the base station.

10. A communication system, performing full-duplex or virtual full-duplex communications, the communication system comprising:
a base station configured to determine a set of user equipments to be scheduled; for a resource at a time slot, select a pair of user equipments to be scheduled from the set of user equipments based on an objective function, and allocate the resource and set corresponding power for the pair of user equipments being scheduled;
wherein, the pair of user equipments comprises an uplink user equipment and a downlink user equipment, and following parameters are taken into account in the objective function: uplink throughput and downlink throughput that can be achieved by the pair of user equipments in the resource at the time slot, and uplink throughput and downlink throughput in the coverage of the base station.
